(19) United States
(12) Patent Application Publication
(10) Pub. No.: US 2006/0199689 A1
(43) Pub. Date: Sep. 7, 2006

(54) Sliding contact guide for transmission

(75) Inventors: Shintarou Yoshimoto, Osaka (JP); Masahiko Konno, Osaka (JP)

Correspondence Address: Howson and Howson;Spring House Corporate Center, Box 457, Spring House, PA, 19477, US

(73) Assignee: Tsubakimoto Chain Co., Osaka (JP)

(21) Appl. No.: 11/343,044

(22) Filed: Jan. 30, 2006

(30) Foreign Application Priority Data
Mar. 7, 2005 (JP) 2005-062377

(51) Int. Cl. F16H 7/08; F16H 7/18

(52) U.S. Cl. 474/111; 474/140

(57) ABSTRACT

In a sliding contact chain guide of the kind used in the timing transmission of an internal combustion engine, the guide body is formed by injection molding of a synthetic resin. The guide body includes reinforcing ribs of substantially uniform width, forming a Y-shaped truss structure.

### FIELD OF THE INVENTION

This invention relates to sliding contact guides for endless, flexible, traveling, transmission media, used to transmit power from a driving shaft to one or more driven shafts in a transmission such as the timing drive of an internal combustion engine.

### BACKGROUND OF THE INVENTION

An automobile engine generally includes a transmission which utilizes an endless, traveling, flexible, transmission medium such as a roller chain, silent chain, toothed belt, or the like, to transmit rotation from the engine crankshaft to one or more camshafts. In such a transmission, sliding contact guides are used to guide the transmission medium. Typically, a fixed guide is disposed in sliding engagement with the tension side of a transmission chain, i.e., the side moving from a driven sprocket to the driving sprocket, and a movable guide is disposed in sliding engagement with the slack side of the chain, i.e., the side moving from the driving sprocket to a driven sprocket. The guides control the path of the chain to prevent vibration, both in the plane of movement of the chain and in directions transverse the plane of movement of the chain. The movable guide also cooperates with a tensioner to maintain appropriate tension in the chain. The movable guide is typically pivoted on a mounting bolt or pin attached to the engine block, while the fixed guide is typically secured to the engine block by plural mounting bolts. A conventional transmission of the kind described above is depicted and explained in detail in the U.S. Pat. No. 6,086,498, granted Jul. 11, 2000.

The guide body of a sliding contact guide is usually formed by injection molding. In a conventional sliding contact guide, as shown in FIG. 3, reinforcing ribs 122 are integrally molded with the guide body 100 on a side surface 120 in order to increase the strength of the guide body. See for example Japanese Laid-Open Patent Publication No. 2003-214504, and U.S.Pat. Nos. 6,645,102, 6,692,390, 6,743,130, 6,796,917, 6,832,966, 6,843,742, 6,849,013, 6,849,014, and 6,890,277.

As shown in FIG. 3, the reinforcing ribs in the above-mentioned conventional sliding contact guide define a plurality of triangles having thick joints J, where the reinforcing ribs 122 meet the outer edge ribs 124.

During injection molding, the thick joints J cool more slowly than the thinner portions of the ribs, causing uneven volumetric shrinkage. As the result, tension is created in the joints, and the strength of the guide is impaired. Uneven shrinkage also results in shrink marks, which impair the outward appearance of the guide. Tension in the joints can also result from the generation of voids or “blow holes” within the thick joints J. These voids can impair the strength and endurance of the guide even if they are not visible on the surface. Furthermore, in a typical conventional molded guide having reinforcing ribs, the reinforcing ribs and the outer edge ribs of the guide body meet at sharp angles. It can be seen from FIG. 3 that three angles are formed at each joint, and that at least one of these three angles is necessarily a sharp angle, i.e., and angle of 60° or less. When one or more of these angles is a sharp angle, failure can result when impact is applied to the guide, due to an effect known as the “notch” effect.

The principal objects of this invention are to avoid the above-mentioned problems of conventional sliding contact guides, to provide a sliding contact guide having improved strength, to avoid premature failure of the guides, and to increase their service life.

### SUMMARY OF THE INVENTION

The sliding contact guide in accordance with the invention comprises an elongated shoe having a guide surface on a front side thereof for sliding contact with a flexible transmission medium traveling along the direction of elongation of the shoe, and a unitary, injection-molded, synthetic resin guide body provided on a back side of the shoe and supporting the shoe. The guide body comprises a pair of elongated, and preferably generally arc-shaped, members spaced from each other and extending along the direction of elongation of the shoe. The guide body also comprising an array of reinforcing ribs connecting the elongated members to each other, the array of reinforcing ribs, together with the elongated members forming a truss-structure composed of Y-shaped truss components, each Y-shaped component being composed of a leg and two arms, the legs and arms having substantially the same width. Each leg extends substantially in normal relationship from one of the elongated members. Each arm is substantially straight and extends from a leg connected to one of the elongated members to a leg connected to the other of the elongated members. The angle between the leg and each of the two arms of each Y-shaped truss component is preferably greater than 90°, and the angle between the two arms of each Y-shaped truss component is preferably at least 60 °.

Preferably, the array of reinforcing ribs comprises a plurality of short rib elements and a plurality of longer rib elements. Each short rib element of a first set of the short rib elements is connected at one end to one of the elongated members and has a second end, the short rib elements of the first set being disposed at intervals along one of the elongated members. Similarly, each short rib element of a second set of the short rib elements, is connected at one end to the other of the elongated members and has a second end, the short rib elements of the second set being disposed at intervals along said other of the elongated members. Each of the short rib elements extends, in substantially normal relationship to the elongated member to which it is connected, toward the other elongated member. The short rib elements on the respective elongated members are disposed in alternating relationship along the direction of elongation of the shoe, and each of a plurality of the short rib elements on each of the elongated members has its second end connected to the second ends of two adjacent short rib elements on the other of the elongated members by a pair of longer rib elements, the longer rib elements connected to each of the short rib elements extending obliquely from the short rib element to which it is connected, thereby forming the Y-shaped truss.

The shoe may be removably connected to one of the elongated members of the guide body. Alternatively, the shoe can be a unitary part of one of the elongated members. In the latter case a slot is preferably formed in the guide body, the slot being open in a direction facing away from the front side of the elongated shoe. The array of reinforcing ribs then comprises ribs on both sides of the slot, and a rigid reinforcing plate is disposed in the slot.

In the case of a pivoted guide, the guide is provided with a boss having a through hole for receiving a mounting shaft on which the guide is pivotable, and one of the ribs is connected directly to the boss. One of the elongated elements may also have a tensioner-engaging portion having an outer surface engageable by the plunger of a tensioner. Preferably, in the latter case, one of the rib elements is connected directly to the tensioner-engaging portion.

By forming reinforcing rib array so that the guide body is in the form of a truss having Y-shaped components, the formation of thick joints between the reinforcing ribs and elongated members of the guide body is avoided, and uneven shrinkage, and the formation of voids, are suppressed. As the result, the strength of the guide is improved. Since the thick joints are eliminated, the dimensional accuracy of the molded guide is improved, and stable travel of a chain or other transmission medium can be realized. Suppression of thermal shrinkage following molding also affords a greater degree of freedom in the design of the shoe and guide body and reduces size variation in the finished product so that consistent high quality can be achieved. Furthermore, since sharp angles between the oblique reinforcing ribs and the elongated, arcuate, members of the guide body are avoided, the likelihood of breakage due to impact is greatly reduced.

A wide variety of materials may be used to form the reinforcing plate. However, the plate is preferably composed of a ferrous metal such as cast iron, stainless steel, or the like. Nonferrous metals which have aluminum, magnesium, titanium, or the like, as their main constituent, engineering plastics such as polyamide resins, and fiber-reinforced plastics and the like may also be used.

There are no particular limitations on the material of the guide body. However, the guide body is preferably composed of a polyamide resin or a similar engineering plastic having high wear resistance and lubricity. Preferred materials include nylon 6, nylon 66, all aromatic nylons, and the like.

### BRIEF DESCRIPTION OF THE DRAWINGS

FIG. 1 is an exploded perspective view showing a first embodiment of the invention;

FIG. 2 is an exploded perspective view showing a second embodiment of the invention;

FIG. 3 is a side elevational view of a conventional movable guide.

FIG. 4 is a schematic elevational view of the timing transmission of a dual overhead cam internal combustion engine equipped with a conventional sliding contact guide and a conventional fixed guide.

### DETAILED DESCRIPTION OF THE PREFERRED EMBODIMENTS

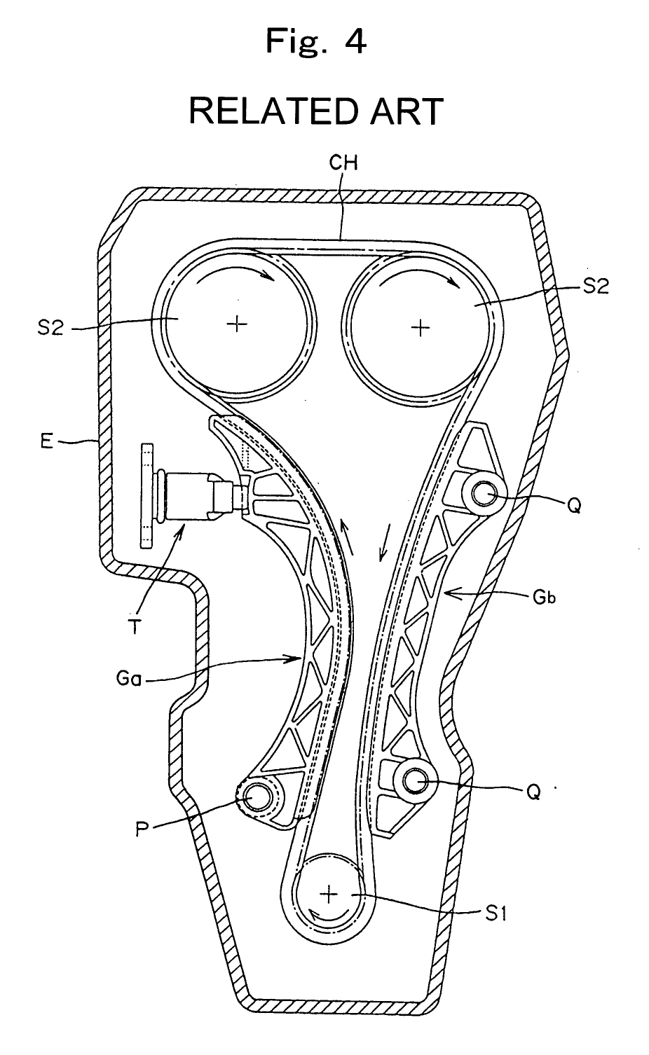

In the transmission shown in FIG. 4, a movable guide Ga and a fixed guide Gb, are provided respectively on the slack and tension sides of a drive chain CH, driven by a crankshaft sprocket S1, driving two camshaft sprockets S2. The movable guide Ga is pivoted on shaft P, which can be a pin, a mounting bolt, or the like. The guide Ga is urged by a tensioner T into sliding contact with the chain. The fixed guide Gb is secured to a wall of a frame E by mounting bolts Q. Both guides control the path of travel of the chain CH.

The movable guide Ga and the fixed guide Gb are similar, differing from each other primarily only in their shapes and in the methods by which they are attached to the engine block. The characterizing features of the invention reside in the structure of the guide bodies and will be described with reference to a movable guide. It should be understood, however, that the invention is applicable to fixed guides as well as to movable guides.

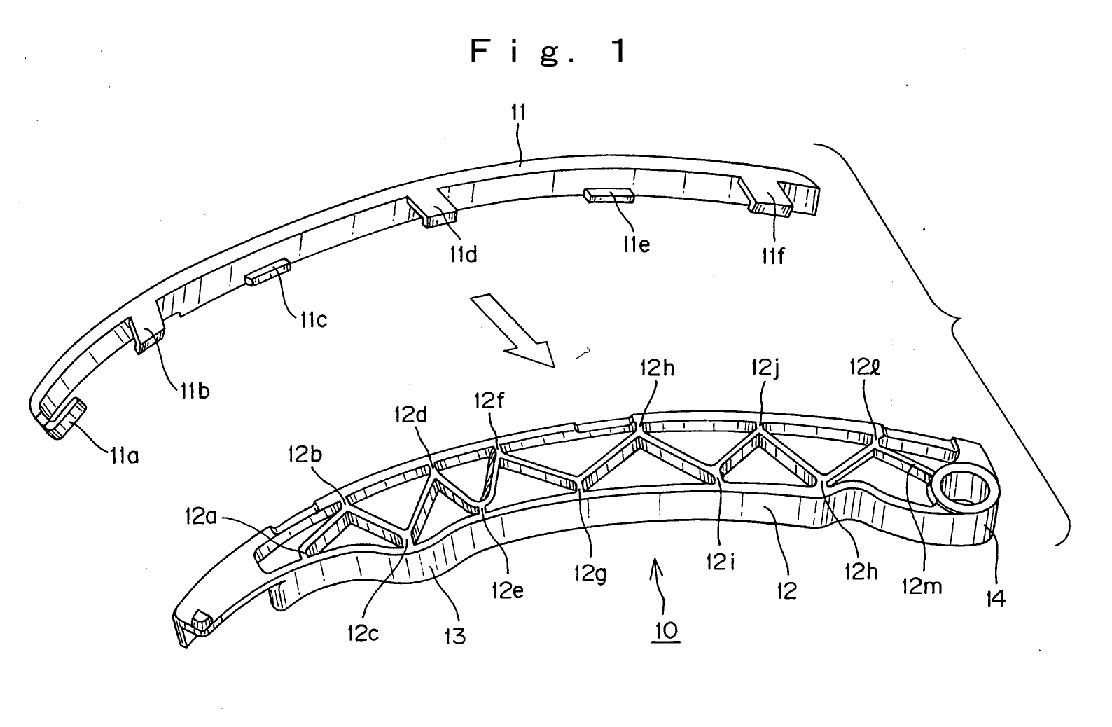

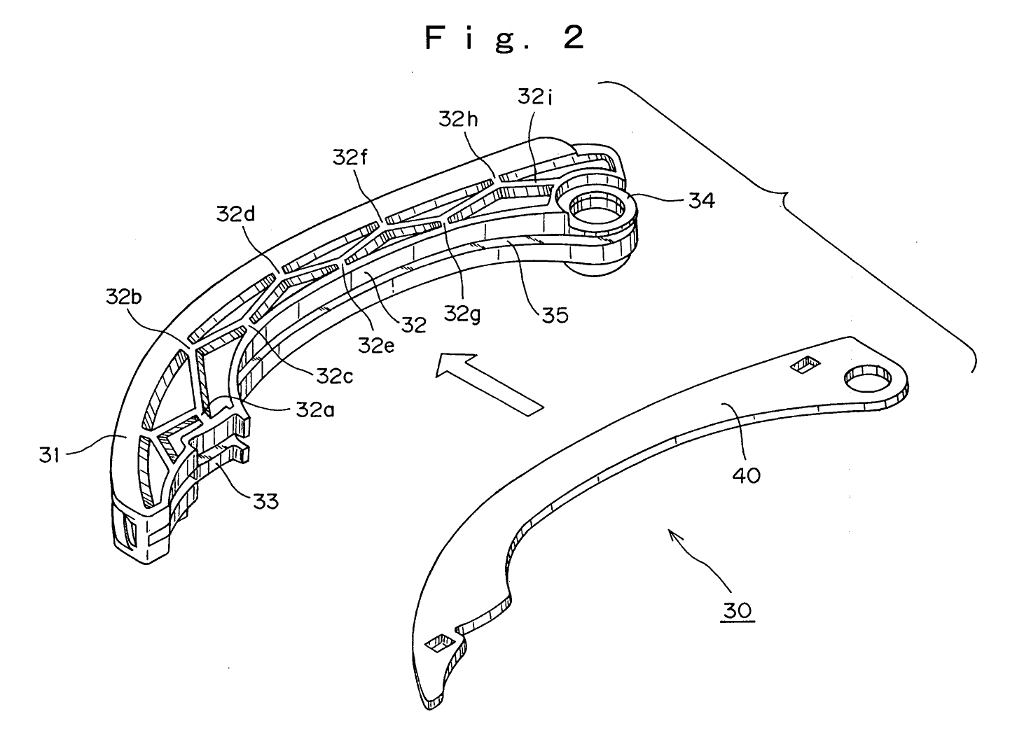

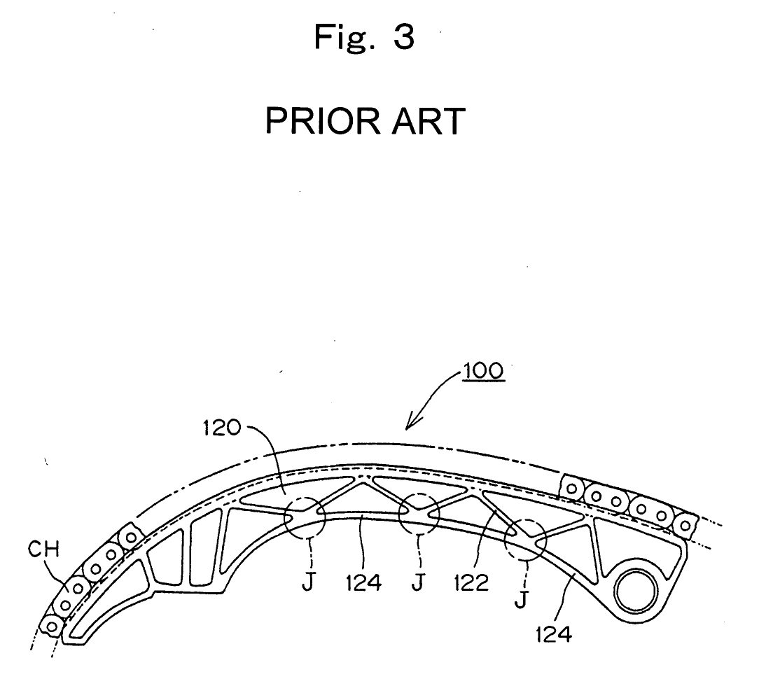

As shown in FIGS. 1 and 2, in each of the two embodiments, the guide body comprises a pair of spaced arcuate members extending along the direction of the length of the guide. The arcuate members are connected by a single intermediate web in the case of FIG. 1, and by two intermediate webs in the case of FIG. 2. In both cases, an array of reinforcing ribs is formed on the outwardly facing web surfaces. Each array of reinforcing ribs is in the form of a truss having Y-shaped truss components. The reinforcing rib structure increases the strength of the guide and its ability to withstand the load applied to the shoe by the chain traveling on the shoe. The Y-shaped truss structure avoids the thick joints J, seen in FIG. 3, which reduce the strength of the guide due to shrinkage and the generation of voids. Furthermore, the Y-shape disperses the applied force, and improves fatigue strength, resulting in longer service life. Additionally, since the reinforcing ribs do not meet the arcuate members at a sharp angle, the notch effect is suppressed, and impact resistance is improved.

In the first embodiment, depicted in FIG. 1, the movable guide 10 includes a shoe 11, which is adapted for sliding contact with a chain. A guide body 12 provided on a back side of the shoe 11 to support the shoe. The shoe 11 has hooks 11a - 11f, which engage one of the arcuate members of the guide body 12, and has a shape conforming to that arcuate member.

The guide body 12 is molded as a unit by injection molding of a synthetic resin. Reinforcing ribs 12a -12l are formed on side surfaces of a web connecting the two elongated arcuate members of the guide body 12, the reinforcing ribs are connected to one another to form a truss structure having Y-shaped components, as shown in FIG. 1. A similar array of ribs (not shown) is formed on the opposite side of the web.

As seen in FIG. 1, the array of ribs comprises short and longer rib elements, all having substantially the same width, measured in directions parallel to the face of the web. The short rib elements extend substantially in normal relationship to the elongated, arcuate, members. The short rib elements attached at intervals to one of the elongated members, are displaced, along the longitudinal direction of the guide, relative to the short rib elements attached at intervals to the opposite elongated member. Thus, the short rib elements on the respective elongated members are in alternating relationship along the length of the guide, i.e., along the direction of elongation of the shoe 11. Longer rib elements extend obliquely from short rib elements on one elongated member to short rib elements on the opposite elongated member. Thus, each of a plurality of the short rib elements on each of the elongated members has an end connected to ends of two adjacent short rib elements on the other of the elongated members by a pair of longer, oblique, rib elements, so that the array of ribs forms a Y-shaped truss. The y-shaped configuration makes it possible for the angle between the leg and each of the two arms of each Y-shaped truss component to be greater than 90°, and for the angle between the two arms to be at least 60°.

A reinforcing rib 12c, and a similar rib (not shown) on the opposite side of the web, are positioned directly behind tensioner contacting portion 13, in order to improve the ability of the guide to sustain the force applied to it by a tensioner. Similarly, rib 12m, and a similar rib (not shown) on the opposite side of the web, meet a boss 14, through which a pivot shaft P extends, thereby enhancing the strength of the boss.

In movable guide 30, as shown in FIG. 2, a shoe 31 and a guide body 32 are molded as a unit from a synthetic resin, and a rigid reinforcing plate 40, which reinforces the guide body 32, is inserted into a longitudinal slot 35, formed in an edge of the guide body 32, and opening in a direction facing opposite to the direction in which the chain-contacting surface of the shoe faces. Reinforcing ribs 32a-32h are formed on the outwardly facing side of a web on one side of the slot 35, and similar ribs (not shown) are formed on the outwardly facing side of a web on the other side of slot 35. The ribs 32a-32h form a truss structure having Y-shaped truss components similar to the Y-shaped truss components in FIG. 1. The guide has a rib 32a (and a similar rib on the opposite side (not shown), both meeting a tensioner contacting portion 33, to enhance the strength of the guide and sustain the force applied to the guide by the tensioner. As in the case of FIG. 1, a rib 32i (and a similar rib on the opposite side (not shown) meets boss 34 and enhances the strength of the boss.

Although the above-described embodiments illustrate the invention as applied to movable guides (that is, tensioner levers), the rib structure of the invention can be applied to a fixed guide, and similar advantages can be realized.

1. A sliding contact guide comprising:
an elongated shoe having a guide surface on a front side thereof for sliding contact with a flexible transmission medium traveling along the direction of elongation of the shoe; and
a unitary, injection-molded, synthetic resin guide body provided on a back side of the shoe and supporting the shoe, the guide body comprising a pair of elongated members spaced from each other and extending along the direction of elongation of the shoe;
the unitary, injection-molded, guide body also comprising an array of reinforcing ribs connecting the elongated members to each other, the array of reinforcing ribs, together with the elongated members forming a truss-structure composed of Y-shaped truss components, each Y-shaped component being composed of a leg and two arms, the legs and arms having substantially the same width, each leg being connected to, and extending substantially in normal relationship from, one of the elongated members, and each arm being substantially straight and extending from a leg connected to one of the elongated members to a leg connected to the other of the elongated members.

2. A sliding contact guide according to claim 1, in which each of said elongated members is substantially arc-shaped.

3. A sliding contact guide according to claim 1, in which the shoe is removably connected to one of the elongated members of the guide body.

4. A sliding contact guide according to claim 1, in which the shoe is a unitary part of one of the elongated members, in which a slot is formed in the guide body, the slot being open in a direction facing away from the front side of the elongated shoe, the array of reinforcing ribs comprising rib elements on both sides of the slot, and including a rigid reinforcing plate disposed in the slot.

5. A sliding contact guide according to claim 1, including a boss having a through hole for receiving a mounting shaft on which the guide is pivotable, and in which one of the ribs is connected directly to the boss.

6. A sliding contact guide according to claim 1, in which one of the elongated members has a tensioner-engaging portion having an outer surface engageable by the plunger of a tensioner, and in which one of the ribs is connected directly to the tensioner-engaging portion.

7. A sliding contact guide according to claim 1, in which the angle between the leg and each of the two arms of each Y-shaped truss component is greater than 90°.

8. A sliding contact guide comprising:
an elongated shoe having a guide surface on a front side thereof for sliding contact with a flexible transmission medium traveling along the direction of elongation of the shoe; and
a unitary, injection-molded, synthetic resin guide body provided on a back side of the shoe and supporting the shoe, the guide body comprising a pair of elongated members spaced from each other and extending along the direction of elongation of the shoe;
the unitary, injection-molded, guide body also comprising an array of reinforcing ribs connecting the elongated members to each other, the array of reinforcing ribs comprising a plurality of short rib elements and a plurality of longer rib elements, all of the rib elements having substantially the same width, and the longer rib elements being substantially straight;
each short rib element of a first set of the short rib elements being connected at one end to one of the elongated members and having a second end, the short rib elements of the first set being disposed at intervals along said one of the elongated members;
each short rib element of a second set of the short rib elements, being connected at one end to the other of the elongated members and having a second end, the short rib elements of the second set being disposed at intervals along said other of the elongated members;
each of the short rib elements extending, in substantially normal relationship to the elongated member to which it is connected, toward the other elongated member, and the short rib elements on the respective elongated members being disposed in alternating relationship along the direction of elongation of the shoe; and
each of a plurality of the short rib elements on each of the elongated members having its second end connected to the second ends of two adjacent short rib elements on the other of the elongated members by a pair of the longer rib elements, the longer rib elements connected to each of the short rib elements extending obliquely from the short rib element to which it is connected, whereby a the array of ribs forms a Y-shaped truss.

9. A sliding contact guide according to claim 8, in which each of said elongated members is substantially arc-shaped.

10. A sliding contact guide according to claim 8, in which the shoe is removably connected to one of the elongated members of the guide body.

11. A sliding contact guide according to claim 8, in which the shoe is a unitary part of one of the elongated members, in which a slot is formed in the guide body, the slot being open in a direction facing away from the front side of the elongated shoe, the array of reinforcing ribs comprising short and longer rib elements on both sides of the slot, and including a rigid reinforcing plate disposed in the slot.

12. A sliding contact guide according to claim 8, including a boss having a through hole for receiving a mounting shaft on which the guide is pivotable, and in which one of the rib elements is connected directly to the boss.

13. A sliding contact guide according to claim 8, in which one of the elongated members has a tensioner-engaging portion having an outer surface engageable by the plunger of a tensioner, and in which one of the rib elements is connected directly to the tensioner-engaging portion.

14. A sliding contact guide according to claim 8, in which the angles between the short and longer rib elements are all greater than 90°.
